(19) United States
(12) Patent Application Publication
(10) Pub. No.: US 2012/0288741 A1
(43) Pub. Date: Nov. 15, 2012

(54) BATTERY ASSEMBLY

(75) Inventors: Andreas Gutsch, Luedinghausen (DE); Tim Schaefer, Harztor (DE); Andreas Fuchs, Leipzig (DE)

(73) Assignee: Li-Tec Battery GmbH, Kamenz (DE)

(21) Appl. No.: 13/500,115

(22) PCT Filed: Sep. 22, 2010
(86) PCT No.: PCT/EP10/05802

§ 371 Date: Jul. 30, 2012

(30) Foreign Application Priority Data
Oct. 5, 2009 (DE) 10 2009 048 250.4

(51) Int. Cl. H01M 2/10

(52) U.S. Cl. 429/100

(57) ABSTRACT

A battery assembly (1) comprises a number of electrochemical cells (2), in particular flat battery cells, which are received in a holding means (3), wherein the holding means (3) has at least one fixing plate (4) which at least indirectly adjoins a electrochemical cell (2), wherein, there is a defined surface pressure between a surface (5) of the electrochemical cell (2) and the fixing plate (4).

Priority application 10 2009 048 250.4 is fully incorporated by reference into the present application

The present invention relates to a battery assembly with at least one electrochemical cell.

EP 1 701 404 A1 shows a battery assembly with a plurality of battery units. Barriers, which can have ribs or coolant channels, are provided between the battery units in each case. The arrangement of battery units and barriers is clamped by means of tensioning bolts.

DE 10 2007 001 590 A1 discloses an electrical energy storage means for a motor vehicle with a plurality of flat cells which have two essentially flat sides. The flat cells are arranged in the manner of a stack one above the other. A cooling plate is in each case provided between two adjacent flat cells. The flat cells and cooling plates are held under prestress.

WO 2005/008825 A2 discloses a clamping device for a stack made up of a plurality of electrochemical cells. The cell units are combined to form a stack with the production of a certain mechanical prestress, a constant surface pressure being applied.

DE 103 23 883 A1 discloses an electrochemical battery, an electrolyte electrode unit being arranged between two pole plates. A pressure pad is provided between two electrolyte electrode units.

WO 93/22124 A1 shows a container for accommodating a battery, which is produced from fibreglass-reinforced plastic.

It is an object of the present invention to produce an improved battery assembly. This object is achieved by means of a battery assembly according to claim 1.

The battery assembly has at least one, i.e. one or a plurality of electrochemical cells, which can in particular be constructed as flat battery cells. The electrochemical cells are received in a holding means, the holding means having at least one fixing plate which at least indirectly adjoins an electrochemical cell, a defined surface pressure being present between a surface of the electrochemical cell and the fixing plate.

In the sense of the invention, an electrochemical cell is to be understood as meaning a device which also has at least one electrode stack. The electrochemical cell furthermore has a casing which seals the electrode stack in a substantially gas- and liquid-tight manner with respect to the surroundings of the electrochemical cell. Conventionally, at least one current conductor is provided, which extends out of the casing.

In the sense of the invention, an electrode stack is to be understood as meaning an apparatus which, as a module of a galvanic cell, is also used for storing chemical energy and emitting electrical energy. Before emitting electrical energy, stored chemical energy is converted into electrical energy. During charging, the electrical energy supplied to the electrode stack or the galvanic cell is converted into chemical energy and stored. To this end, the electrode stack has a plurality of layers, namely at least one anode layer, a cathode layer and a separator layer. The layers are placed or stacked one above the other, the separator layer being arranged at least to some extent between an anode layer and a cathode layer. Preferably, this sequence of the layers repeats itself within the electrode stack multiple times. Preferably, some electrodes are in particular electrically connected, particularly parallel-connected, to one another. Preferably, the layers are wound up to form an electrode winding. In the following, the term “electrode stack” is also used for electrode winding.

In the sense of the invention, a holding means is to be understood as meaning an apparatus which can hold at least one electrochemical cell at least temporarily. A holding means can preferably hold a plurality of electrochemical cells at the same time and/or protect the same electrochemical cells from unplanned displacement.

A fixing plate is in this case particularly understood as meaning a component which has an at least to some extent essentially planarly structured surface section which is constructed for adjoining at least one of the electrochemical cells. The essentially planarly constructed surface section is preferably structured in such a manner in terms of its shape that a largest boundary surface of an electrochemical cell, which can preferably essentially be structured planarly, can come to completely adjoin the surface section.

A defined surface pressure is in this case in particular to be understood as meaning that the fixing plate and the electrochemical cell are subjected to pressure against one another at the surfaces bearing against one another in each case in a conscious manner and/or with a preferably settable force creation means. The loading with pressure can be transferred to further components of the battery assembly. The loading with pressure can be applied by means of separate clamping means. The clamping means can be produced from flexible or partially flexible material. The material can be thermally conductive. The clamping means can be produced from rubber. The clamping means can be produced from belts. Further, the loading with pressure can also be created by means of elastic elements, the shape of which changes under the action of force.

Taking account of static coefficient of friction, a certain holding action of the electrochemical cell can be achieved even in a direction parallel to the respective contact surfaces by means of the defined surface pressure between the electrochemical cell and the fixing plate. In this respect, a non-positive connection between the electrochemical cell and the fixing plate can result. In the case of a non-positive connection, the holding together of two components can be ensured purely by means of the holding force. The forces to be transferred between the components in this case also occur tangentially to the contact surfaces of the two components. Further, movements of the electrochemical cell can preferably be transferred directly onto the fixing plates, as a result of which a vibration of the electrochemical cells can be reduced or prevented. Preferably, as a result, a fixed clamping of the electrochemical cells between a pair of fixing plates result. In this case, the electrochemical cell does not necessarily have to, but can directly adjoin one or two fixing plates. An indirect adjoining of at least one of the fixing plates with the electrochemical cell may also be sufficient. In particular, indirect adjoining between a fixing plate and an electrochemical cell is also present if a further electrochemical cell or an elastic layer is arranged between fixing plate and electrochemical cell. Due to the surface pressure, other regions, which can effect force transfer between the electrochemical cell and the holding means, are fundamentally relieved. This can in particular relieve or completely free the critical region of the sealing seam between two jacket parts from forces to be transferred. If a largest boundary surface of the electrochemical cell adjoins the fixing plate completely or also only to an in particular large extent, this may reduce or prevent a bending of the electrochemical cell. In particular, the electrochemical cell can be mounted in a play-free manner by means of the holding apparatus. This preferably means that no relative movement takes place between parts of the battery assembly, particularly between the fixing plates and the electrochemical cells. A certain movement of the electrochemical cell, which can result due to an elastic deformation of the electrochemical cell and/or the fixing plate in the case of an adjoining of a fixing plate, remains unaffected by this. Further, a movement of the electrochemical cell, which can result due to an axial yielding of the fixing plate in particular due to a mounting of the fixing plate which yields axially in the stack direction, remains unaffected thereby.

Preferably, the holding means has at least one frame element, one of the fixing plates being securely connected to one of the frame elements. In this case, the fixing plate is preferably directly connected to the corresponding frame element. In particular, this means that the fixing plate is not exclusively indirectly non-positively connected to the corresponding frame element via an electrochemical cell. Preferably, all of the fixing plates can also be securely connected to a frame element.

In the sense of the present invention, a frame element is to be understood as meaning any constructive apparatus which is suitable for or can contribute to stabilising the electrochemical cell mechanically against environmental influences and which can be securely connected to the packaging of the cell during production of the cell. As the wording already indicates, a frame element is preferably a constituent of an essentially frame-shaped apparatus, the function of which essentially consists in lending mechanical stability to an electrochemical cell. The frame element can be a battery housing or at least a part of a battery housing.

One or a plurality of fixing plates can releasably be connected to in each case one or a plurality of the frame elements. In this case, one fixing plate can preferably be screwed to one or a plurality of the frame elements. Further, a fixing plate can be clamped between two frame elements. The two frame elements can in this case be clamped against one another by means of screwing means.

Alternatively or in combination therewith, one or a plurality of the fixing plates can be connected in a materially bonded or integral manner with one of the frame elements in each case. Materially bonded connection is in this case understood as meaning a connection of two components which are held together by means of atomic or molecular forces. Materially bonded connections of this type can in particular be produced by means of adhesive bonding or welding. An integral connection in particular means a one-piece construction of fixing plate and frame element.

Alternatively or in combination therewith, at least one of the fixing plates can be retained in a groove of at least one of the frame elements. If the frame element is a peripheral frame element which is in particular arranged in an annular manner around the electrochemical cell, the groove can be constructed as a peripheral groove. A peripheral groove can also be formed on frame elements attached to one another, in particular if the frame elements attached to one another together form a peripheral frame element. The fixing plate can in this case preferably be held in the groove in a non-positive and/or positive manner.

A secure clamping of the fixing plate with respect to the frame element can preferably be effected by means of the previously mentioned types of fixing of the fixing plate on the frame element. Secure clamping in this case in particular means that forces and moments which act on the fixing plate can be completely transferred to the frame element. In the present case, however, on account of the clamping of a plurality of electrochemical cells and fixing plates one behind the other, a transfer of forces via in each case adjacent electrochemical cells and fixing plates can result in each case. In this respect, the present battery arrangement can also be statically overdefined with respect to the forces and moments arising at the electrochemical cells and fixing plates.

Alternatively or in combination therewith, one of the frame elements can also be a holding frame.

The surface pressure between the fixing plate and the electrochemical cell is preferably dimensioned in such a manner that the electrochemical cell can be held in a non-positive manner on at least one fixing plate. Preferably, one of the electrochemical cells is in this case held between two fixing plates in a non-positive manner. This means that further components can also be provided between the respective fixing plates on each of the electrochemical cells. In this respect, this formulation also means that also only an indirect contact can be present between the two fixing plates and the electrochemical cell lying therebetween. Preferably, the electrochemical cell is held between two fixing plates in an exclusively non-positive manner. The formulation “in an exclusively non-positive manner” in this case means that all forces which can effect a relative movement between electrochemical cell and fixing plate parallel to the contact surfaces are transferred via static or sliding friction onto the fixing plate. Small movements which can take place due to excessive external force action or increased vibration remain unaffected. Likewise unaffected thereby is the fact that, due to other contact points of the electrochemical cell with other components, a certain force transfer from electrochemical cell to the component can take place. This is for example possible by means of the electrical contacting of a current conductor with a connection element.

Preferably, a separate elastic layer is arranged between one of the electrochemical cells and one of the fixing plates. The elastic layer preferably has an expansion which corresponds to an expansion of a largest boundary surface of the electrochemical cell. In this respect, a largest boundary surface of the electrochemical cell can adjoin the separate elastic layer completely. A separate elastic layer stands out in particular in that the same can change its shape, its cross-sectional thickness in particular. As a result, in turn, the separate elastic layer can apply a force against the deformation direction, so that a prestress force can in turn originate from the separate elastic layer itself. The separate elastic layer can consequently be used for building a prestress. Further, the separate elastic layer can also be used for compensating shape changes. In particular, the separate elastic layer can enable an expansion of the electrochemical cell, which can in particular take place by means of a heating or a pressure increase within the jacket of the electrochemical cell.

Preferably, an elastic layer directly adjoins one of the electrochemical cells. Due to the direct adjoining of the elastic layer with the electrochemical cell, local shape changes at the electrochemical cell can be compensated by means of the elastic layer. Thus, in particular, local bulgings of the elastic layer can be compensated without an increased pressure application taking place at a certain point of the electrochemical cell. The separate elastic layer can therefore act as a pressure damping element, in particular as a local pressure damping element.

The fixing plate is preferably formed as a thermally conductive plate. The thermally conductive plate is in this case preferably produced from one material which has good thermal conductivity, in particular a higher thermal conductivity than unalloyed steel. In this respect, the fixing plate can, in addition to the previously mentioned holding function for the electrochemical cell, also have a thermal function, namely the dissipation and/or supply of heat from the electrochemical call or to the electrochemical cell. The heat can be transferred from the thermally conductive plate to the frame element or from the frame element to the thermally conductive plate. In this case, the previously mentioned fixing types and the associated fixing means can be used as thermal bridges between the fixing plates and the frame elements.

Particularly, but not only if the fixing plates are also used as thermally conductive elements, it is advantageous if each of the electrochemical cells directly adjoins a fixing plate. In the case of the functioning of the fixing plate as holding element, this has the advantage that forces to be transferred, particularly weight forces, can be transferred directly, that is to say without diversions and as a result avoiding unnecessary force flows, to the fixing plates. If the fixing plates also take on the function of a thermally conductive plate, by means of the direct adjoining of electrochemical cell and fixing plate good heat transfer is promoted between these elements.

Preferably, each of the fixing plates is securely connected to a frame element. The secure connection can preferably be undertaken with one of the above-mentioned fixing types. The fact that each fixing plate is then securely connected to the frame element means that the forces, in particular the weight forces of the electrochemical cells which are adjacent or adjoin fixing plates, are transferred by the respective fixing plates directly to the frame element. Due to the direct force transfer from each fixing plate to a frame element, the prestress force to be applied can be kept small, as a result of which the required surface pressure between fixing plate and electrochemical cell can also generally be kept small.

Preferably, the fixing plate is connected to a heat exchanging means. A heat exchanging means is in this case particularly an apparatus which can transfer heat or thermal energy from one material to another material. One of the materials, particularly the material to which thermal energy is transferred, is preferably a fluid, particularly a gas flow or a liquid flow. By using a heat exchanging means, the cooling action or the heating action for the electrochemical cell can be improved. Further, the dissipation or supply of thermal energy from the or to the electrochemical cell for heating or cooling purposes can be used for heating or cooling purposes in a vehicle.

The battery assembly is further structured in such a manner on the basis of the previously mentioned construction measures and/or further construction measures that a spatial expansion of the electrochemical cells is possible, a spatial expansion along a stacking direction in particular is possible. The stacking direction is in this case defined by the spatial arrangement of the electrochemical cells, the fixing plates and if appropriate the elastic layers and runs in this case transversely through all of the previously mentioned components. A spatial expansion can in this case preferably be caused on the basis of a temperature change and/or a pressure change in the interior of an electrochemical cell.

The battery assembly is further preferably formed in such a manner that a defined damage to at least one electrochemical cell takes place if a defined expansion of the electrochemical cell is present. A defined expansion of the electrochemical cell can in particular be present if a certain temperature, namely a burst temperature, and/or a certain internal pressure, namely a burst pressure, is present in the interior of the electrochemical cell. In the case of the presence of the burst condition, namely the burst pressure and/or the burst temperature, it can be assumed that a damaging of the electrochemical cell exists, which may set the electrochemical cell on fire or may lead to an explosion of the electrochemical cell. In a situation of this type, it is advantageous if in particular at a predetermined breaking point, the jacket of the electrochemical cell can be damaged in a targeted manner, so that a material exchange, particularly a gas exchange, of the interior of the electrochemical cell with the surroundings is possible, in order in this case to particularly produce a pressure equalisation and/or temperature equalisation. To this end, cutting means in particular can be provided, which in the case of the defined expansion can come into contact with a jacket of the electrochemical cell and therefore damage the same. Alternatively, the jacket can be weakened in a targeted manner at a point, in particular by means of at least one indicated perforation which can tear open in the case of the presence of the burst condition.

In a preferred embodiment, in the case of a defined expansion, a current conductor of an electrochemical cell can be subjected to tensile loading in such a manner that a seal of the electrochemical cell is damaged, particularly in the region of a current conductor passage. In this case, a current conductor is preferably securely connected to a connector element which is preferably at least indirectly securely connected to the holding apparatus. In the case of the expansion of the electrochemical cell, a relative position change is effected between current conductor duct on the electrochemical cell with respect to the fixing point of the current conductor on the connector element, which position change can subject the current conductor to tensile loading. This tensile loading in turn can be supported at the sealing region at which the current conductor protrudes through the casing. As the sealing region preferably cannot withstand a loading of this type, the casing may be damaged in this region, which can lead to an opening of the casing in this region and in turn to a material exchange between the interior of the electrochemical cell and the surroundings.

Further advantages, features and application possibilities of the present invention arise from the following description in connection with the figures. In the figures:

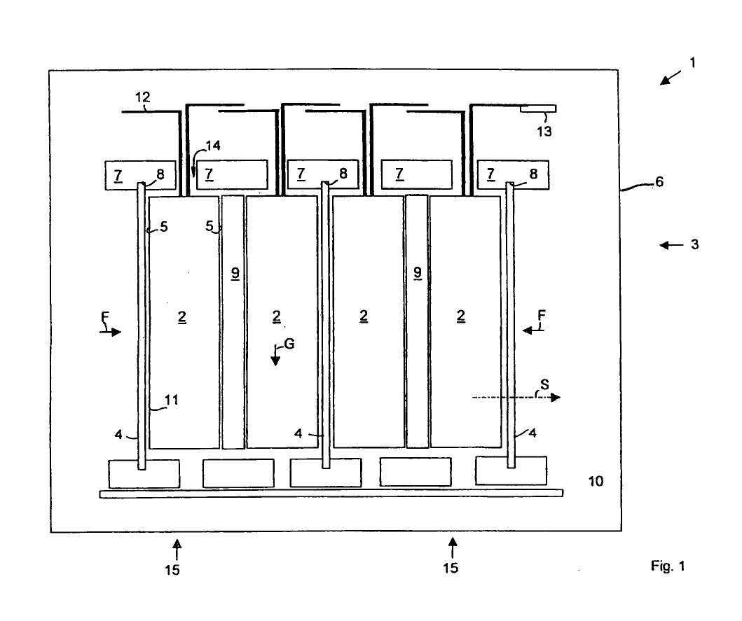

FIG. 1 schematically shows a battery assembly in a first embodiment in a side view;

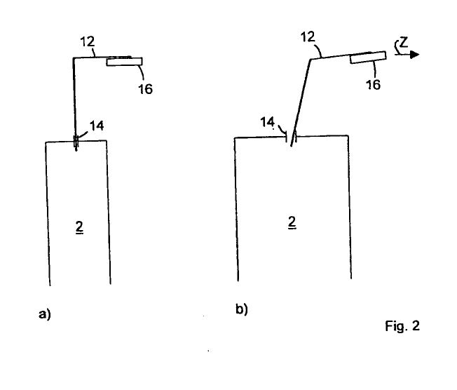

FIG. 2 shows an electrochemical cell in detail
a) in the case of regular expansion,
b) in the case of excessive expansion;

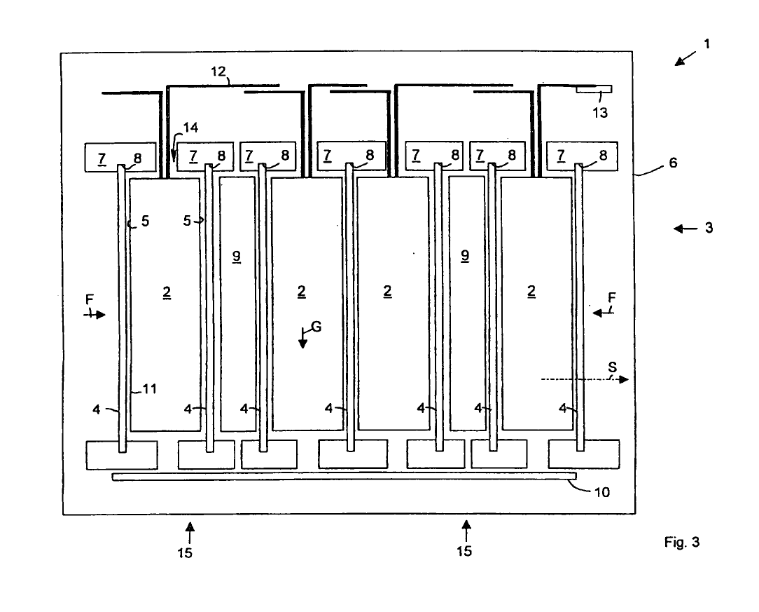

FIG. 3 schematically shows a battery assembly in a second embodiment in a side view.

FIG. 1 shows a battery assembly 1 according to the invention in a first embodiment. The battery assembly has a plurality of electrochemical cells 2, of which by way of example four electrochemical cells 2 are shown. The battery assembly 1 furthermore has further electrochemical cells which are not illustrated. The electrochemical cells 2 in turn in each case have an electrode stack which is not illustrated and which is arranged within a casing 11 of the electrochemical cell 2. Further, an electrochemical cell 2 in each case has two current conductors 12 which extend out of the casing 11 in a sealing region 14. The two current conductors 12 of an electrochemical cell are arranged in different image planes.

The current conductors 12 of the electrochemical cells are in each case connected to current conductors 12 of adjacently arranged electrochemical cells 2. A current conductor 12 of an outermost electrochemical cell 2 is electrically conductively connected to a connector element 13. Likewise, a further current conductor of an electrochemical cell, which is arranged at the end and is not illustrated, is electrically conductively connected to a connector element which is not illustrated. In this respect, the electrochemical cells 2 provided in the battery assembly 1 are connected to one another in series. Other possibilities of wiring the electrochemical cells are also fundamentally conceivable however, parallel connection in particular.

The electrochemical cells 2 are formed as flat battery cells. The electrochemical cells 2 are in this case essentially prismatically shaped with rectangular base surfaces in each case. In this respect, the electrochemical cells 2 are of square construction. In this case, the electrochemical cells have a length and width which are larger by a multiple than a cross-sectional thickness of the electrochemical cell 2. This essentially results in two largest side areas of the electrochemical cell, which in each case form a surface 5 on one of the largest side areas.

Adjacent to the surfaces 5 in each case is either a fixing plate 4 or an elastic layer 9. In FIG. 1, the electrochemical cells 2, the fixing plates 4 and also the elastic layers 9 are in each case illustrated spaced apart from one another. This spacing which is merely shown, is only used for improved illustration and delimiting the components shown in the drawing however. Actually, the electrochemical cells 2 are in each case directly adjacent to the adjacent fixing plate 4 or to the adjacent elastic layer 9. Likewise, the mutually facing current conductors 12 of different electrochemical cells are adjacent to one another and electrically conductively connected to one another.

The combination made up of electrochemical cells 2, fixing plates 4 and elastic layers 9 stacked one on top of the other along a stacking direction S is subjected to a compressive force F by means of clamping means which are not illustrated. The compressive force F spreads through the entire combination. Thus, the fixing plates 4 bear with the surfaces 5 of the electrochemical cells 2 against one another with a certain surface pressure. Likewise, the surfaces 5 of the electrochemical cells 2 bear with the elastic layers 9 against one another with a certain surface pressure. In this respect, forces are mutually transferred from the components bearing against one another. Taking account of a static or sliding friction coefficient, weight forces can also be transferred in particular transversely to the stack direction S, in particular from an electrochemical cell 2 to a fixing plate 4. In this case, the compressive force F is dimensioned in such a manner that the electrochemical cells are completely held by the static friction on adjacent components resulting from the surface pressure and cannot slide out of the composite transversely to the stacking direction S. As a result, each electrochemical cell 2 is exclusively held in the combination by means of the static friction resulting from the surface pressure, so that no further measures are provided for holding the electrochemical cell 2. In particular, it can be seen that no further holding means are provided in the region of the sealing region 14. Also, no further holding means are provided, which sit on a seam of two parts of the jacket 11. In this case, it is to be recognised that each of the electrochemical cells 2 is directly adjacent to a fixing plate 4, so that the weight force G of an electrochemical cell 2 can be transferred directly via the surface 5 in a non-positive manner to the adjacent fixing plate 4.

The fixing plates 4 are further securely connected to a holding frame 7 in each case. The holding frame 7 is a peripheral component which annularly surrounds the fixing plate 4 and in each case encloses two adjacent electrochemical cells 2 at least to some extent. In this case, the fixing plate 4 is accommodated in a surrounding groove 8 of the holding frame 7. The holding frame 7 is in this case constructed in two parts and comprises two U-shaped frame parts which are not illustrated in any more detail. Initially, the fixing plate 4 is inserted into the groove 8 of one of the frame parts. Subsequently, the other frame part is placed onto the fixing plate 4 so that the fixing plate 4 protrudes into the groove 8 of this frame part also. Subsequently, the two frame parts are together connected to one another to form the holding frame 7. In this respect, the fixing plate 4 is accommodated in a positive manner in the groove 8 of the holding frame 7. The holding frame 7 is further securely connected to the battery housing 6 by means of fixing means which are not illustrated. The battery housing 6, the fixing plates 4 and also the holding frame 7 together form a holding means 3.

The fixing plates 4 are structured as thermally conductive plates. Thus, the fixing plates 4 are produced from a material which has a good thermal conductivity. Aluminium or magnesium in particular are suitable as material for this, as in addition to good thermal conductivity, the same also have a low specific weight. Further, the fixing plates can have ribs for surface enlargement. Alternatively or in combination therewith, the fixing plates 4 can also have coolant channels. The fixing plates 4 are in indirect contact with a heat exchanging means 10 which is merely illustrated schematically. The heat exchanging means 10 is connected to a coolant circuit which is further connected to a cooling circuit of a vehicle or is a constituent of the cooling circuit of a vehicle.

In the present embodiment of the battery assembly 1, a preassembly unit 15 is in each case formed from two fixing plates 4, two electrochemical cells 2 and also an elastic layer 9. The stack sequence of the preassembly unit 15 in the stacking direction S is as follows: fixing plate 4, electrochemical cell 2, elastic layer 9, electrochemical cell 2, fixing plate 4. It can be seen that the outermost fixing plates 4 are at the same time a constituent of the adjacent preassembly units 15 at the same time in each case. In this case, the elastic layer 9 is arranged directly between two electrochemical cells 2. As the electrochemical cells 2 are in turn arranged between two fixing plates 4, the elastic layer 9 is arranged both between the two fixing plates 4 and between an electrochemical cell 2 and a fixing plate 4, even if only indirectly.

The elastic layer 9 in this case allows an expansion of the electrochemical cells 2 in the stacking direction S in particular. The elastic layer 9 can in this case change its shape under the action of force. In the case of compression, that is to say if the surfaces 5 of the adjacently arranged electrochemical cells, which are arranged adjacently to the elastic layer, move relatively to one another and thus reduce the space for the accommodation of the elastic layer 9, an elastic force, with which the elastic layer in turn loads the electrochemical cells 2, increases. This is spread by the electrochemical cells 2 and subsequently supported by the fixing plates 4. Further, the elastic force can be forwarded via the closest preassembly units 15 and subsequently supported by the clamping means which are not illustrated. In this respect, the compressive force F can be influenced, particularly increased, by the elasticity of the elastic layers 9.

An expansion of the electrochemical cells 2 occurs in particular if a temperature rise and/or a pressure rise takes place in an inner space of the electrochemical cell 2. In the event of the reaching of a burst pressure and/or a burst temperature in the interior of the electrochemical cell 2, an expansion of the electrochemical cell 2 can take place to an extent that a desired damaging at a predetermined breaking point of the electrochemical cell 2 takes place. This is explained in more detail hereinafter on the basis of FIG. 2.

By way of example, FIG. 2 shows an electrochemical cell 2 of the battery assembly according to FIG. 1. It can be seen that a current conductor 12 of the electrochemical cell 2 is connected to a fixing element 16. The fixing element 16 is in turn securely connected to the holding means 3 of the battery assembly 1 and thus immovably held with respect to the battery housing 6. FIG. 2a) in this case shows the state of the electrochemical cell 2 in normal operation, that is to say the temperature and/or the pressure in the interior of the electrochemical cell 2 lie below the burst temperature or the burst pressure. The current conductor 12 is orientated at an angle and extends out of the casing 11 at the sealing region 14.

In FIG. 2b), a state of the electrochemical cell 2 is to be recognised, in which in the interior of the electrochemical cell 2, the temperature and/or the pressure have achieved or exceeded the burst temperature or the burst pressure. Due to the high temperature and/or the high pressure in the interior of the electrochemical cell 2, the electrochemical cell 2 has expanded. In this case, it can be seen that a relative length change of the sealing region 14 relatively to the fixing element 16 has taken place. As the current conductor 12 is initially securely connected to the sealing region 14 and the fixing element 16, the current conductor 12 is subjected to tensile loading. This has the effect that the angling of the current conductor 12 is flattened. Further, a bending loading of the region of the current conductor 12, which protrudes through the casing 11 at the sealing region 14, results. This bending loading effects a widening of the sealing region 14, which from a certain level effects the at least partial destruction of the seal in the sealing region 14. Due to this destruction of the seal in the sealing region 14, the casing 11 becomes leaky and material can escape from the interior of the electrochemical cell 2 to the outside. A temperature or pressure relief can consequently result. The current conductor 12 and the sealing region 14 in this case act together as a predetermined breaking point.

FIG. 3 shows a second embodiment of the battery assembly 1 according to the invention. The battery assembly 1 according to FIG. 3 substantially corresponds to the battery assembly 1 according to FIG. 1. In this respect, in the following, only the differences from the battery assembly according to FIG. 1 are covered.

Fundamentally, the stack sequence of the electrochemical cells 2, fixing plates 4 and elastic layers 9 is changed compared to the battery assembly according to FIG. 1. It can be seen that a fixing plate 4 is now also provided between the elastic layers 9 and the adjacent electrochemical cell 2 in each case. In this respect, each electrochemical cell 2 and each elastic layer 9 is surrounded by two sides of fixing plates 4 and is therefore adjacent to two fixing plates 4 in each case. This arrangement has the advantage that heat dissipation from the electrochemical cells 2 can be simplified if the fixing plates 4 are at the same time also formed as thermally conductive elements.

In order to transfer an expansion of the electrochemical cells to the elastic layer 9, it is beneficial that the fixing plate 4 is held between the electrochemical cell 2 and the elastic layer 9 in a displaceable manner at least to a certain extent in the stacking direction S with respect to the battery housing 6.

### REFERENCE LIST

1 Battery assembly

2 Electrochemical cell

3 Holding means

4 Fixing plate

5 Surface

6 Battery housing

7 Holding frame

8 Groove

9 Elastic layer

10 Heat exchanging means

11 Casing

12 Current conductor

13 Connector element

14 Sealing region

15 Preassembly unit

16 Fixing element

F Compressive force

G Weight force

Z Pulling force

S Stacking direction

1-17. (canceled)

18. A battery assembly comprising:
at least one electrochemical cell which is received in a holding unit including at least one frame element and at least one fixing plate which at least indirectly adjoins the electrochemical cell,
wherein there is defined surface pressure between a surface of the electrochemical cell and the fixing plate, wherein one of the fixing plates is securely connected at least indirectly to one of the frame elements, and at least one of the fixing plates is retained in a groove of one of the frame elements.

19. The battery assembly according to claim 18, wherein a separate elastic layer is arranged at least between one of the electrochemical cells and one of the fixing plates.

20. The battery assembly according to claim 18, wherein at least one of the frame elements is a holding frame.

21. The battery assembly according to claim 18, wherein at least one of the fixing plates is releasably connected to one of the frame elements.

22. The battery assembly according to claim 18 wherein at least one of the fixing plates is connected in a materially bonded or integral manner with one of the frame elements.

23. The battery assembly according to claim 18, wherein at least one of the electrochemical cells is retained between two fixing plates in a non-positive manner.

24. The battery assembly according to claim 18, wherein at least one of the frame elements is a battery housing.

25. The battery assembly according to claim 18, wherein at least one elastic layer directly adjoins one of the electrochemical cells.

26. The battery assembly according to claim 18, wherein at least one fixing plate is formed as a thermally conductive plate.

27. The battery assembly according to claim 18, wherein each of the electrochemical cells adjoins at least one fixing plate.

28. The battery assembly according to claim 18, wherein at least one of the fixing plates is held in a displaceable manner with respect to other elements of the housing means.

29. The battery assembly according to claim 18, wherein the fixing plate is connected to a heat exchanging means.

30. The battery assembly according to claim 18, wherein spatial expanding of the electrochemical cell is possible.

31. The battery assembly according to claim 30, wherein in the case of a defined expansion of the electrochemical cell, a defined damaging of the electrochemical cell takes place.

32. The battery assembly according to claim 30, wherein in the case of a defined expansion of the electrochemical cell, a current conductor of the electrochemical cell is subjected to tensile loading in such a manner that a seal of the electrochemical cell is damaged in the region of a current conductor passage.

33. The battery assembly according to claim 18, wherein the electrochemical cell is a flat battery cell.

34. The battery assembly according to claim 18, wherein the groove of one of the frame elements is a surrounding groove.

35. The battery assembly according to claim 23, wherein the at least one of the electrochemical cells is retained between the two fixing plates in an exclusively non-positive manner.

36. The battery assembly according to claim 27, wherein each of the electrochemical cells directly adjoins at least one fixing plate.

37. The battery assembly according to claim 30, wherein the spatial expanding is along a stacking direction.
